(19) United States
(12) Patent Application Publication
(10) Pub. No.: US 2005/0039402 A1
(43) Pub. Date: Feb. 24, 2005

(54) Modular fall protection system

(75) Inventors: Richard W. Murphy, Stuart, FL (US); John Joseph Murphy, Stuart, FL (US)

Correspondence Address: CHRISTOPHER & WEISBERG, P.A., 200 EAST LAS OLAS BOULEVARD, SUITE 2040, FORT LAUDERDALE, FL, 33301, US

(73) Assignee: Innovative Safety Products Incorporated

(21) Appl. No.: 10/780,338

(22) Filed: Feb. 17, 2004

Related U.S. Application Data
(60) Provisional application No. 60/496,084, filed on Aug. 19, 2003.
(60) Provisional application No. 60/496,085, filed on Aug. 19, 2003.

(51) Int. Cl. E06B 7/00

(52) U.S. Cl. 49/57

(57) ABSTRACT

A wall opening fall protection support system is provided having a pair of brackets, each bracket of the pair having a substantially planar mounting portion, a support portion, a retaining portion including a locking element, and a standoff element, wherein the retaining portion is resiliently joined to the support portion. The system can further include a rail securable to each bracket by the retaining portion so as to be at least partially surrounded by the support portion, the retaining portion and the standoff element.

### CROSS-REFERENCE TO RELATED APPLICATION

This application is related to and claims priority of U.S. patent application Ser. No. 10/372,881, filed Feb. 24, 2003, entitled WALL OPENING FALL PROTECTION SUPPORT BRACKETS, which is related to and claims priority of U.S. Provisional Patent Application Ser. No. 60/433,710 filed Dec. 16, 2002, entitled WALL OPENING FALL PROTECTION SUPPORT BRACKETS. This application is also related to and claims priority of U.S. Provisional Patent Application No. Ser. No. 60/496,084, filed Aug. 19, 2003, entitled WALL OPENING FALL PROTECTION SUPPORT BRACKETS and U.S. Provisional Patent Application No. Ser. No. 60/496,085, filed Aug. 19, 2003, entitled OPENING FALL PROTECTION RAIL SUPPORTS, the entirety of all of the above being incorporated herein by reference.

### STATEMENT REGARDING FEDERALLY SPONSORED RESEARCH OR DEVELOPMENT

n/a

### FIELD OF THE INVENTION

The present invention relates to a method and system for enhancing safety at a construction site, and more particularly to a system for hindering inadvertent passage through a wall opening.

### BACKGROUND OF THE INVENTION

Part of the process of constructing buildings includes the creation or definition of spaces that will become doors and windows in what are otherwise substantially solid walls. However, as the doors and windows themselves can be relatively expensive and easily damaged during active construction, the doors, windows, and elevators are often installed after much construction work has been accomplished. Further, as the door and window openings are often a primary passageway for introduction of building supplies, it is desired, if not imperative to have the largest possible, unimpeded openings.

In low, one level buildings, unobstructed wall openings present little danger. However, as a building increases in height to two or more levels, the danger associated with unobstructed or guarded wall openings increases. Specifically, if a construction worker falls from the building due to accidental passage through a wall opening, there is a high likelihood of injury or death.

In recognition of the serious danger related to falling from such openings, the United States Occupational Safety and Health Administration (OSHA) requires that an obstruction be placed in wall openings at a height of 42 inches, plus or minus three inches, so as to withstand 200 pounds falling into it in an “outward” and/or “downward” direction. The OSHA requirements are set forth in detail in 29 CFR 1926.502. In practice, these obstructions are pieces of wood, such as “2×4's” that are nailed to the wall on opposite sides of the opening. However, as described above, the wall openings are primary passages for building materials to and from buildings. Thus, the obstructions must be removed to allow passage and replaced following passage. The obstructions must also be removed when furring strips are installed on the walls.

It has been discovered that boards that are nailed into a wall so as to be easily removed, do not provide adequate resistance to falling forces. However, when a board is repeatedly, securely nailed to a wall, the wall can become severely damaged. Further, it has been discovered that because of the tedium in ripping a board from a wall and renailing it each time equipment or material pass through an opening being protected, that the opening is often left unguarded in contravention to OSHA guidelines.

It would therefore be desirable to provide a system for blocking a wall opening in accordance with OSHA guidelines that is so easy to use that it actually will be used.

### SUMMARY OF THE INVENTION

The present invention advantageously provides a method and system for enhancing safety at a construction site, and more particularly to a system for hindering inadvertent passage through a wall opening.

In an exemplary embodiment, a wall opening fall protection support system includes a pair of brackets, each bracket of the pair having a mounting portion, a support portion and a retaining portion; and a rail, wherein the rail is securable to each bracket by the retaining portion. More particularly the system can include a pair of brackets, each bracket of the pair having a substantially planar mounting portion, a support portion, a retaining portion including a locking element, and a standoff element, wherein the retaining portion is resiliently joined to the support portion; and a rail, wherein the rail is securable to each bracket by the retaining portion so as to be at least partially surrounded by the support portion, the retaining portion and the standoff element.

In yet another embodiment, a bracket includes a substantially planar mounting portion, a substantially planar support portion extending orthogonally from the mounting portion, and a substantially planar retaining portion extending from the mounting portion, the retaining portion being substantially coplanar with the support portion.

The brackets of the invention can provide a fall protection system for use with walls and movable stanchions, wherein brackets of the same or different configuration are provided that are securable to the walls and stanchions, along with 2″ by 4″ by 8′ rails, wherein the brackets are adapted to engage the rails.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1a illustrates a wall opening fall protection system of the present invention in use to obstruct an opening in a building under construction.

FIG. 1b is a wall opening fall protection support bracket in accordance with the invention as shown in FIG. 1a;

FIG. 2 is a front perspective view of the bracket of FIG. 1b;

FIG. 3 is top view thereof;

FIG. 4 a left side view thereof, the right side being a mirror image thereof;

FIG. 5 is a front view thereof;

FIG. 6 is a rear view thereof;

FIG. 7 is a front perspective view of an alternative embodiment of the bracket shown in FIGS. 1-6;

FIG. 8 is a top view of the bracket of FIG. 7;

FIG. 9 is a bottom view of the bracket of FIG. 7;

FIG. 10 is a front view of the bracket of FIG. 7;

FIG. 11 is a rear view of the bracket of FIG. 7;

FIG. 12 is a left side view of the bracket of FIG. 7;

FIG. 13 is a right side view of the bracket of FIG. 7;

FIG. 14 shows the bracket of FIG. 7 installed;

FIG. 15 is a front perspective view of yet another embodiment of the bracket;

FIG. 16 is a top view of the bracket of FIG. 15;

FIG. 17 is a bottom view of the bracket of FIG. 15;

FIG. 18 is front view of the bracket of FIG. 15;

FIG. 19 is a rear view of the bracket of FIG. 15;

FIG. 20 is a left side view of the bracket of FIG. 15;

FIG. 21 is a right side view of the bracket of FIG. 15;

FIG. 22 illustrates the bracket of FIG. 15 installed;

FIG. 23 is a perspective view of yet another embodiment of the bracket viewed from the left front;

FIG. 24 is a front view of the bracket of FIG. 23;

FIG. 25 is a top view of the bracket of FIG. 23;

FIG. 26 is a right side view of the bracket of FIG. 23;

FIG. 27 is a left side view of the bracket of FIG. 23;

FIG. 28 is a rear view of the bracket of FIG. 23;

FIG. 29 is a bottom view of the bracket of FIG. 23; and

FIG. 30 illustrates use of a system incorporating brackets of FIGS. 7, 15, and 23.

### DETAILED DESCRIPTION OF THE INVENTION

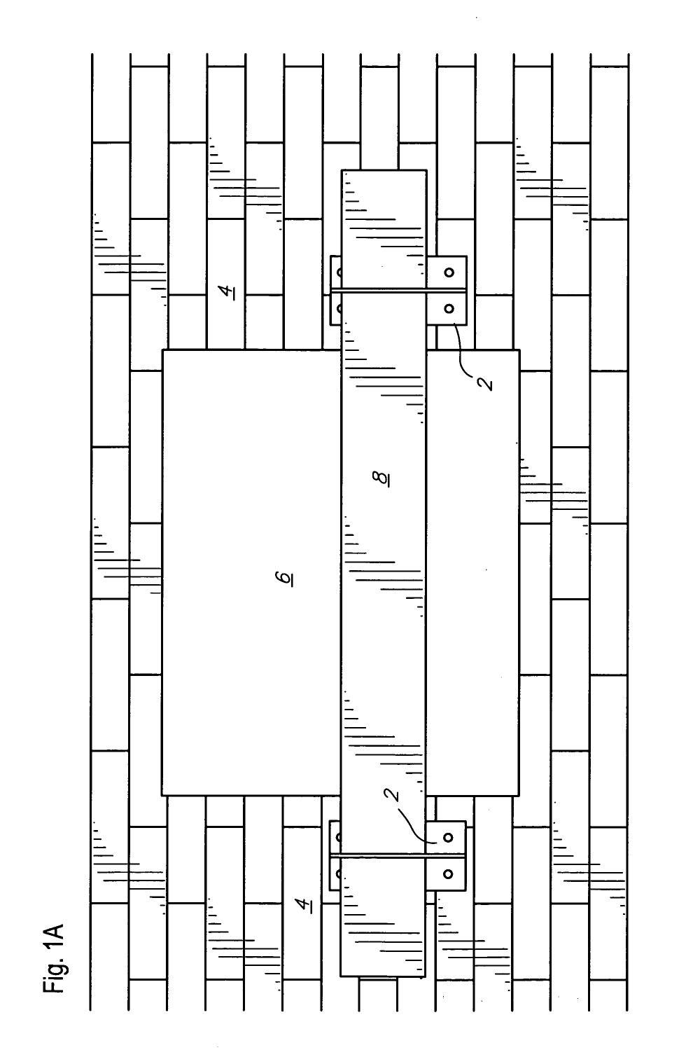

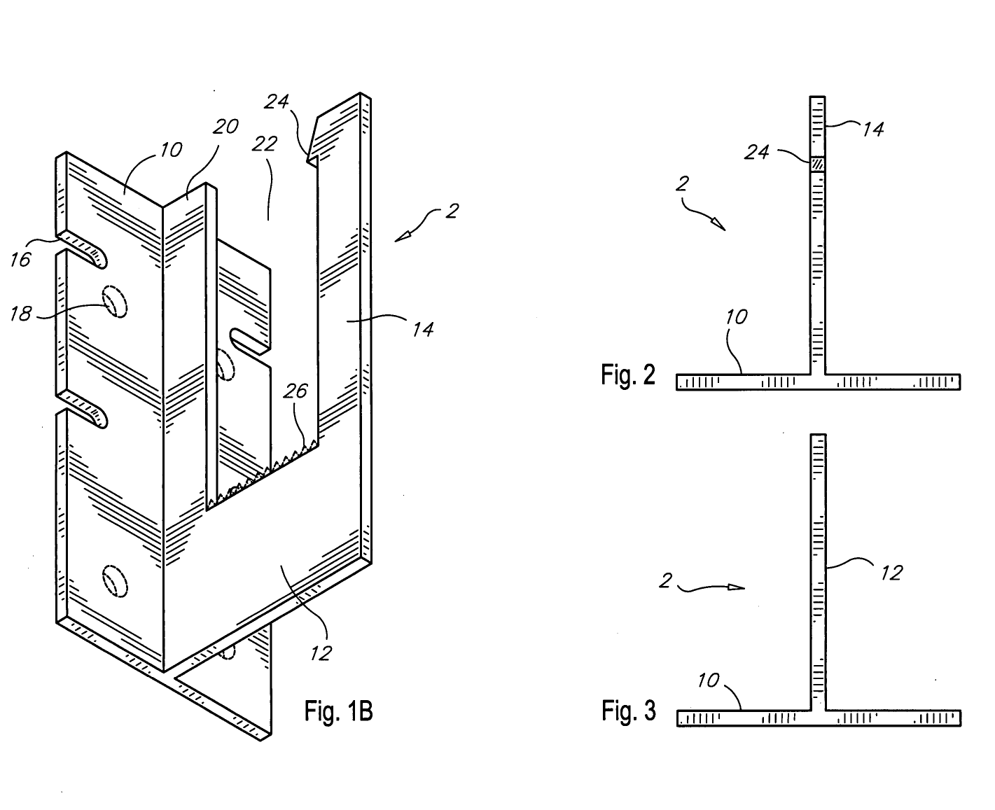

The present invention and its attendant advantages are best understood by viewing the invention in context or use, after which the specific structural details of the system components are described. Accordingly, we begin by referring to FIG. 1a, which illustrates a wall opening fall protection system of the present invention in use. The system includes a pair of brackets 2 secured to a wall 4 on opposite sides of an opening 6 (e.g., door, window, elevator) defined by the wall. A rail 8 is supported and retained by the brackets so as to meet OSHA fall protection requirements. Although the invention is compatible with rails of different configurations, the system shown is configured to use the ubiquitous two-inch by four inch cross-section wooden members commonly used in almost all phases of typical construction projects. In use, the rail 8 is easily removed and replaced within the brackets 2 as required to permit passage through the opening 6.

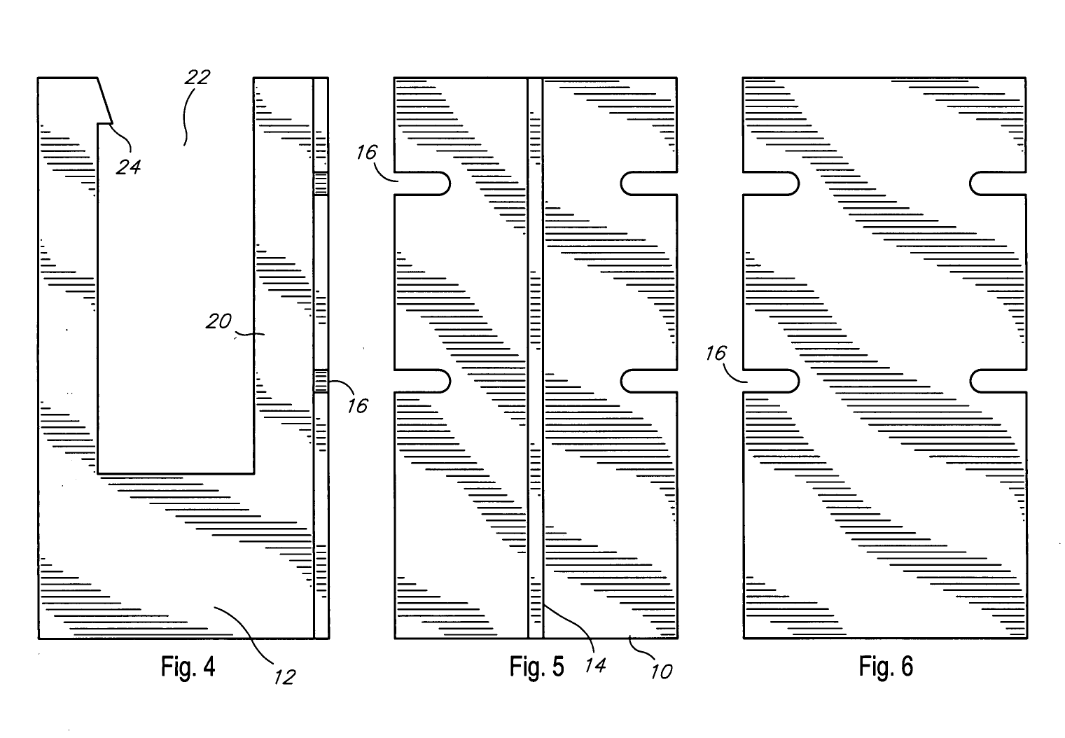

Referring now to FIG. 1b, an exemplary safety bracket in accordance with the invention is illustrated, wherein the bracket includes a mounting portion 10, a support portion 12 and a retaining portion 14. FIGS. 2-6, although not described separately below, illustrate the various features of the bracket described herein with respect to FIG. 1b from differing perspectives.

As shown, the mounting portion 10 is a substantially planar element. The mounting portion is provided with one or more apertures therethrough that are dimensioned to receive screws, nails, tapcons, or bolts. As shown, the apertures can be notches 16 in the periphery of the mounting portion 10 or holes that are away from the periphery. Although two symmetrically located apertures (notches) on opposite sides of the mounting portion 10 are shown, fewer or more apertures can be provided depending on the type of fixation device used (e.g., screw, bolt, tapcon) and the composition of the material to which the bracket is to be secured.

The bracket can further include a standoff element 20 that extends from the mounting portion 10. The standoff element 20 allows for easier grasping of the rail 8 (shown in FIG. 1a). In the exemplary embodiment the standoff element 20 extends about one inch from the mounting portion 10 to provide room for placement of furring on the wall 4. Thus, the standoff element 20, the support portion 12 and the retaining portion 14 define a receiving notch 22 for the rail. In the exemplary embodiment, the receiving notch 22 is defined to have a substantially identical profile as the rail (e.g., a two inch by four inch notch).

The receiving notch 22 can be characterized as generally “U” shaped, wherein the “bottom” of the U is flat and wherein the support portion 12 defines the bottom of the “U.” To facilitate easy placement and removal of the rail 8 within the notch 22, the retaining portion 14 can be movable with respect to the support portion. In the exemplary embodiment, the bracket is made of a high density plastic or polymer and the retaining portion 14 is thus resiliently formed with or joined to the support portion 12.

To help ensure that the rail 8 is not too readily dislodged from the bracket 2, engagement means can be provided to inhibit movement of the rail 8 with respect to one or both of the brackets 2. For example, a locking element 24 can be provided to inhibit vertical motion of the rail 8 from the bracket 2. As shown, the locking element 24 can be a protuberance on the retaining portion 14 that extends over the support portion 12 to partially cover the top of the rail 8. In other embodiments, the locking element can include a strap, band, or clip that extends from the top of the retaining portion to the top of the standoff element.

Additionally, the engagement means can include one or more of the inwardly directed faces of the support portion 12, retaining portion 14, and/or standoff element 20 being provided with fixation enhancements such as “tacky” adhesive or textured surfaces to inhibit lateral movement of the rail 8. For example, as shown in FIG. 1, the support portion 12 can be provided with “teeth” or serrations 26 that engage the rail 8 when the rail is placed into the notch 22.

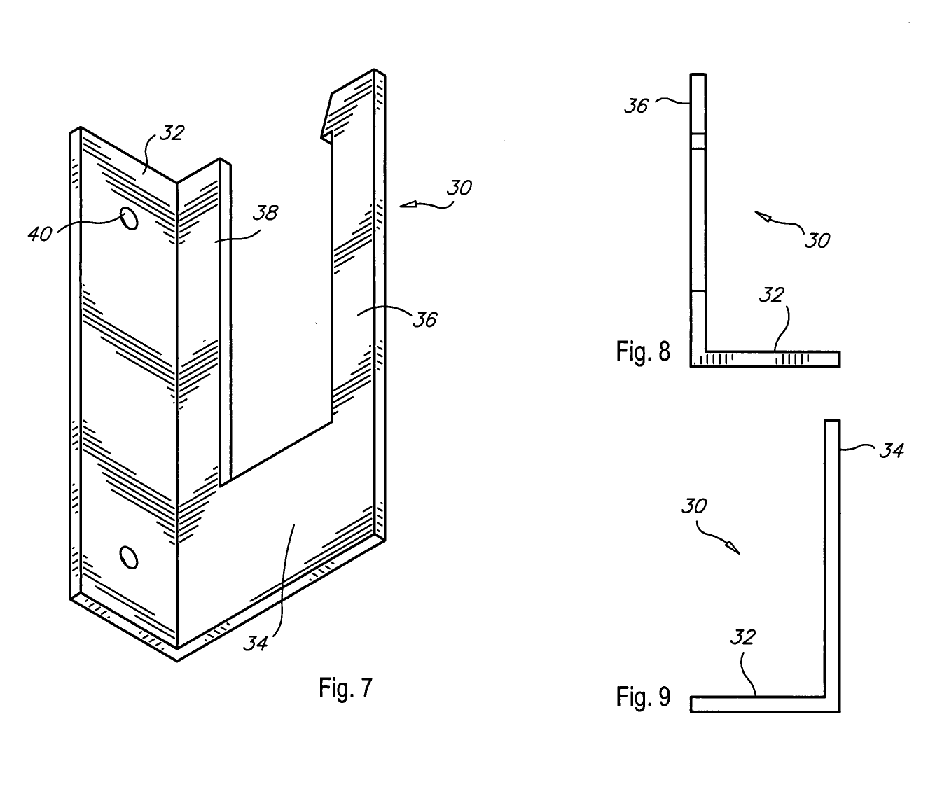

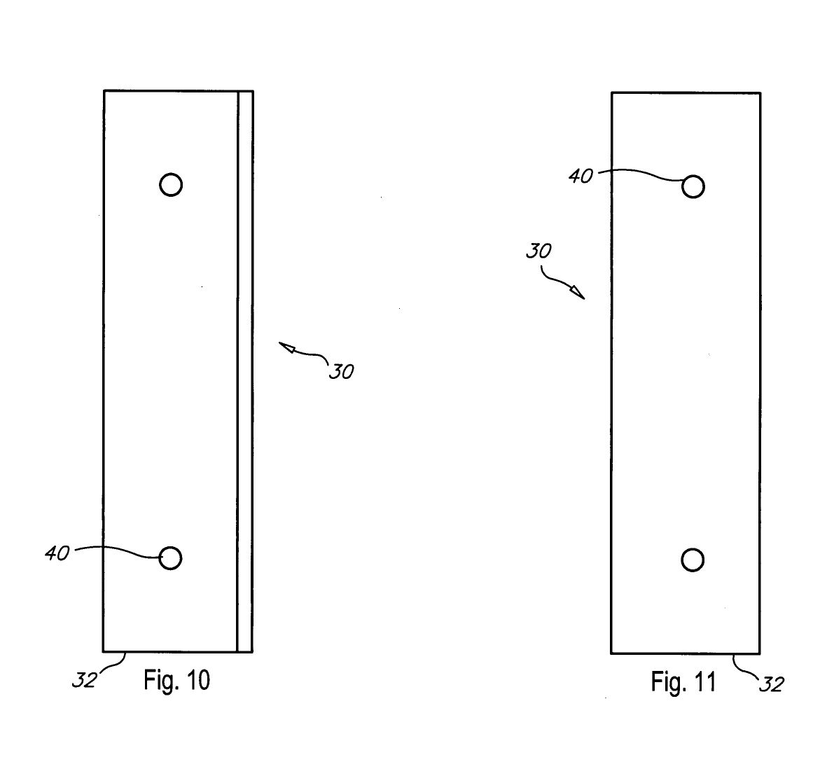

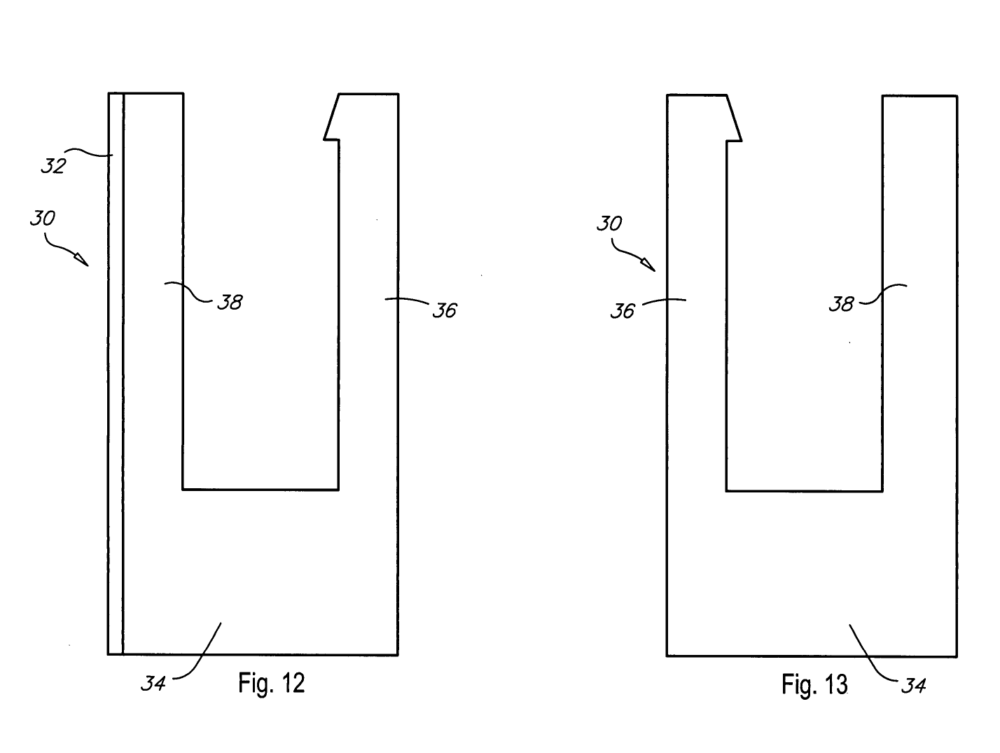

Turning now to FIGS. 7 through 13, an alternative embodiment of the bracket 2 shown in FIGS. 1-6 is presented. As shown in perspective in FIG. 7, a bracket 30 includes a mounting portion 32, a support portion 34, retaining portion 36, and stand-off element 38. It will be noted that in all other respects, except for the exemplary placement of screw or nail holes 40, this bracket 30 is substantially identical to the bracket 2 of FIGS. 1 through 6, except that the mounting portion 32 of the bracket 30 only extends to one side of the support portion 34 and stand-off element 38. As illustrated, the mounting portion 32 extends to the left side; however, the mounting portion can also extend only from the right side. FIGS. 8-13, although not described separately below, illustrate the various features of the bracket 30 from differing perspectives.

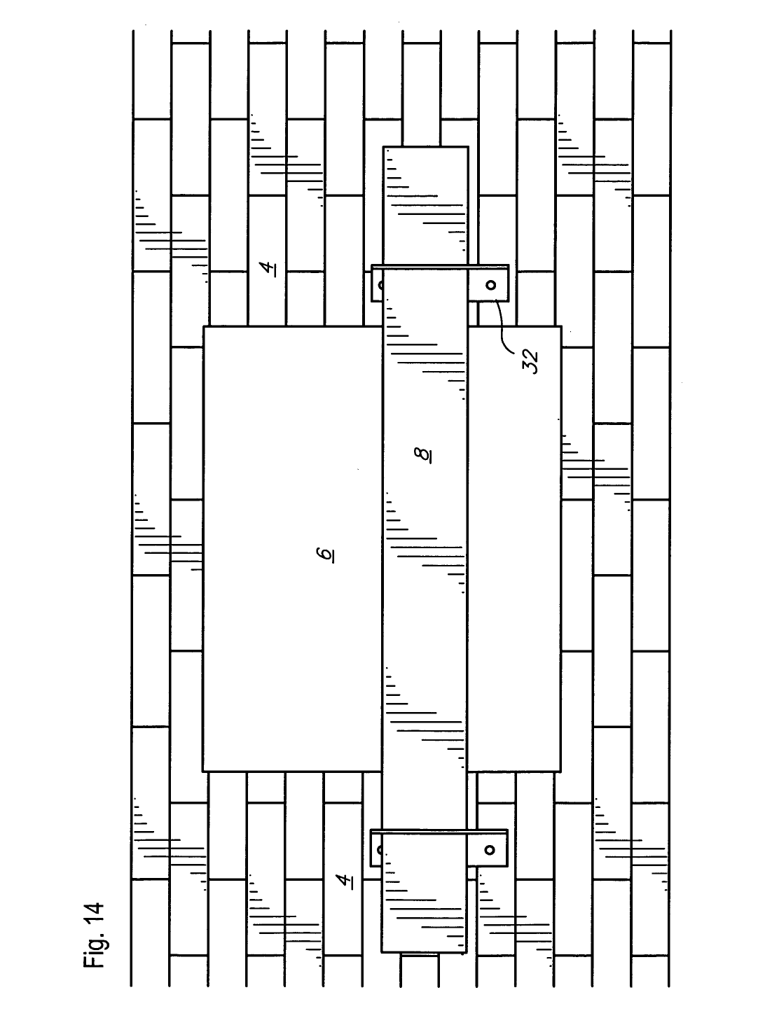

FIG. 14 shows a pair of brackets 30, as shown in FIGS. 7-13, installed in a manner similar to that depicted in FIG. 1A. A rail 8 is suspended between and engaged by the brackets 30 as described hereinabove with respect to FIGS. 1-6 to impede passage through the opening 6 in the wall 4.

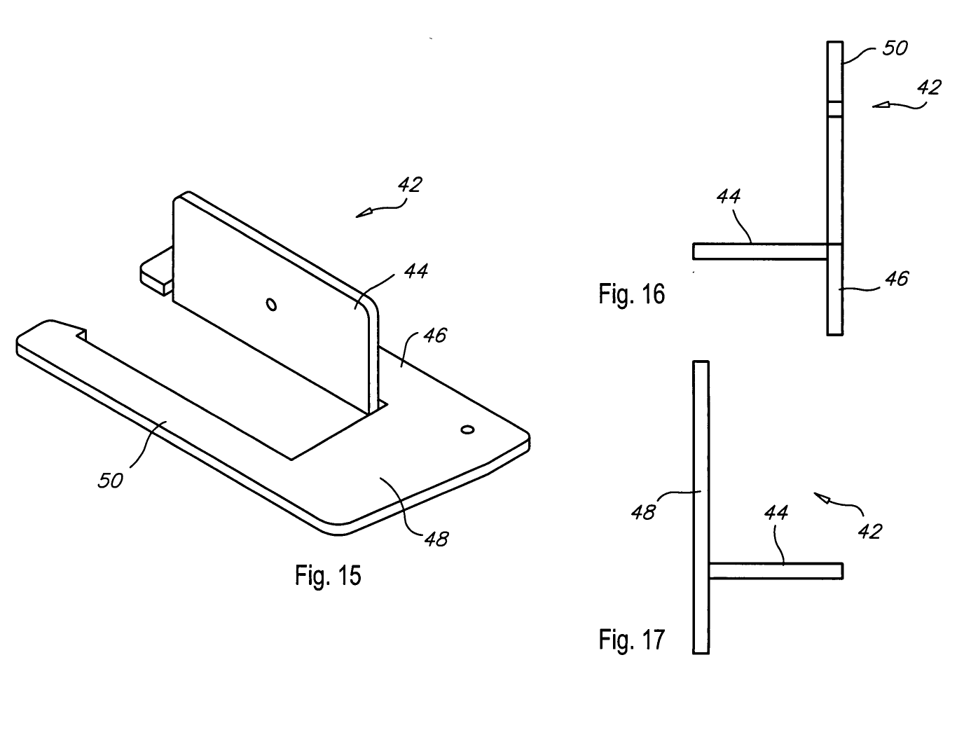

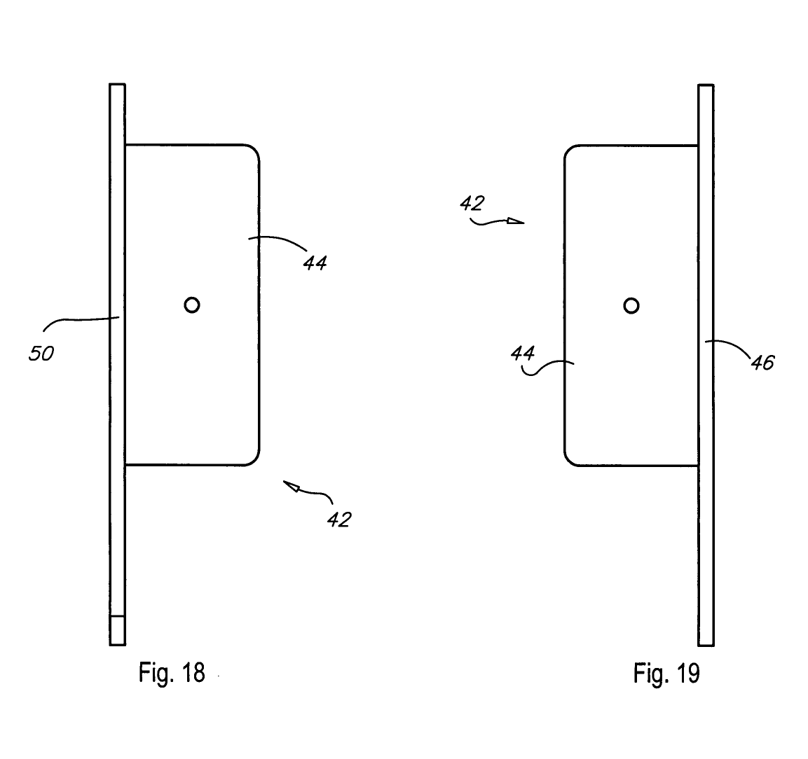

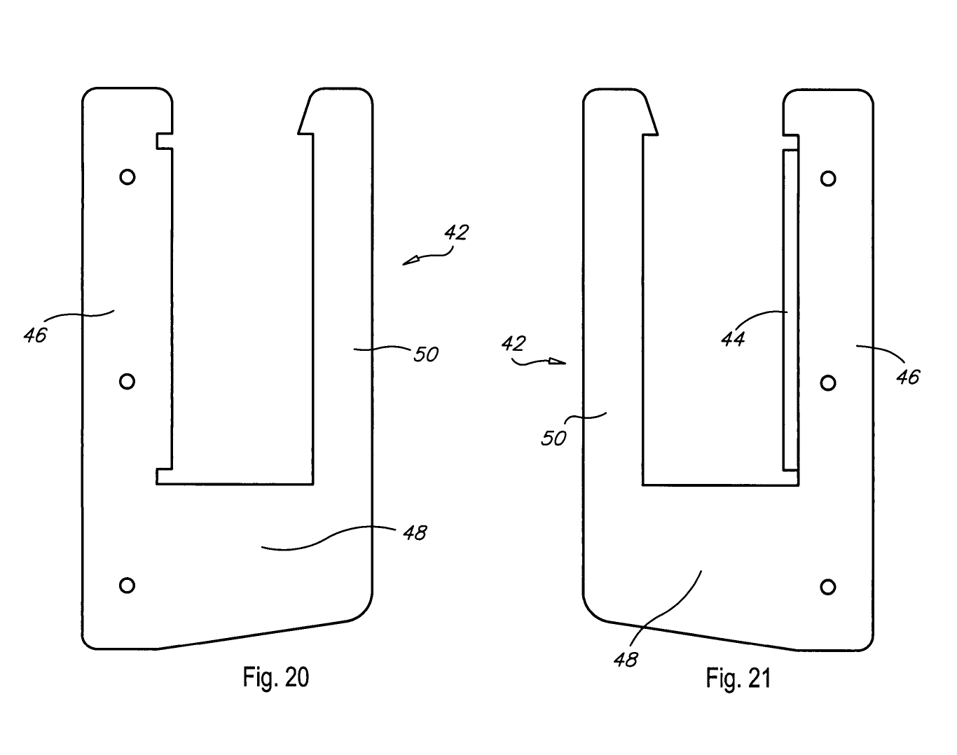

FIG. 15 is a perspective view of bracket 42 in accordance with the invention, wherein a first mounting portion 44 extends orthogonally with respect to a second mounting portion 46 that is substantially co-planar with a support portion 48 and a retaining portion 50. As shown, the first and second mounting portions 44 and 46, respectively are angled at 90 degrees with respect to each other. Thus, the mounting portions 44 and 46 can be secured to two different surfaces to enhance the mounting of the bracket 42. FIGS. 16-21, although not described separately below, illustrate the various features of the bracket 42 from differing perspectives.

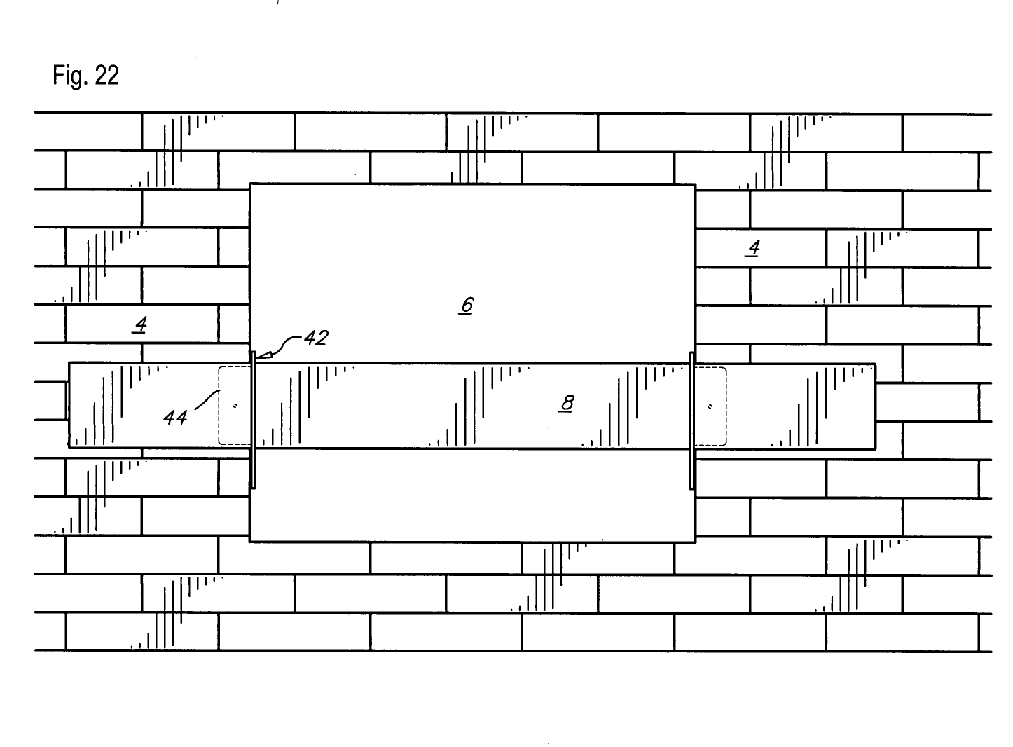

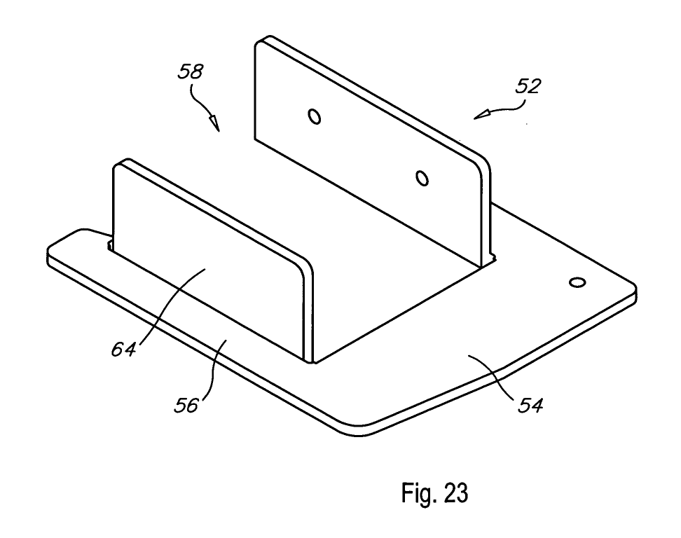

FIG. 22 illustrates a pair of brackets 42 as shown in FIGS. 15-21 installed in a manner generally similar to that depicted in FIGS. 1A and 14. A rail 8 is suspended between and engaged by the brackets 42 as described hereinabove to impede passage through the opening 6 in the wall 4. However, in this installation the first mounting portion 44 of each bracket is secured the wall and the second mounting portion 46 (not visible in this view) is secured to inner, opposing faces that define the opening 6.

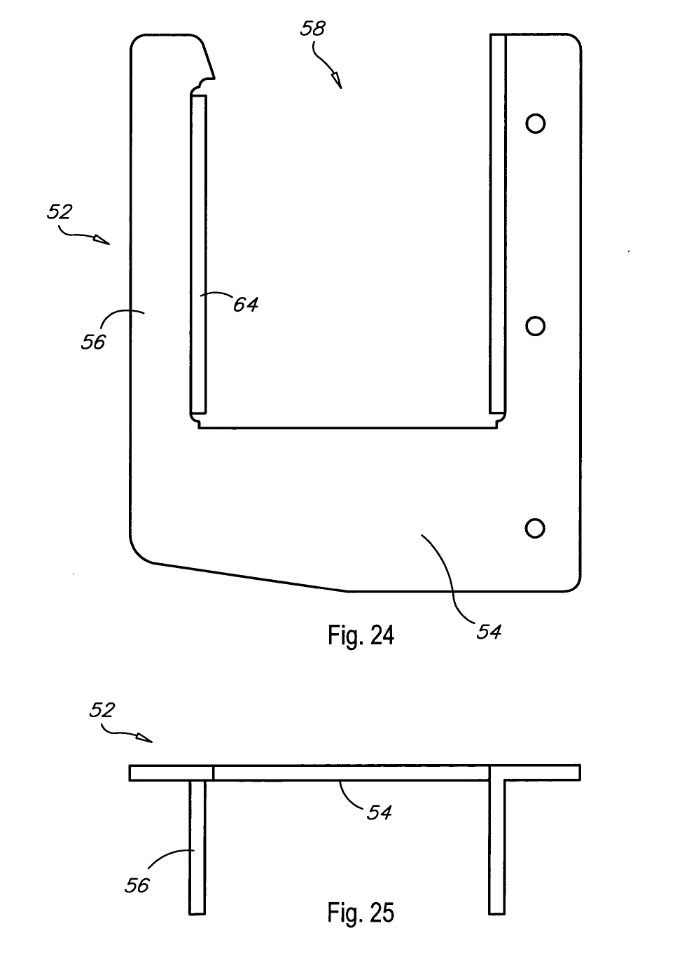

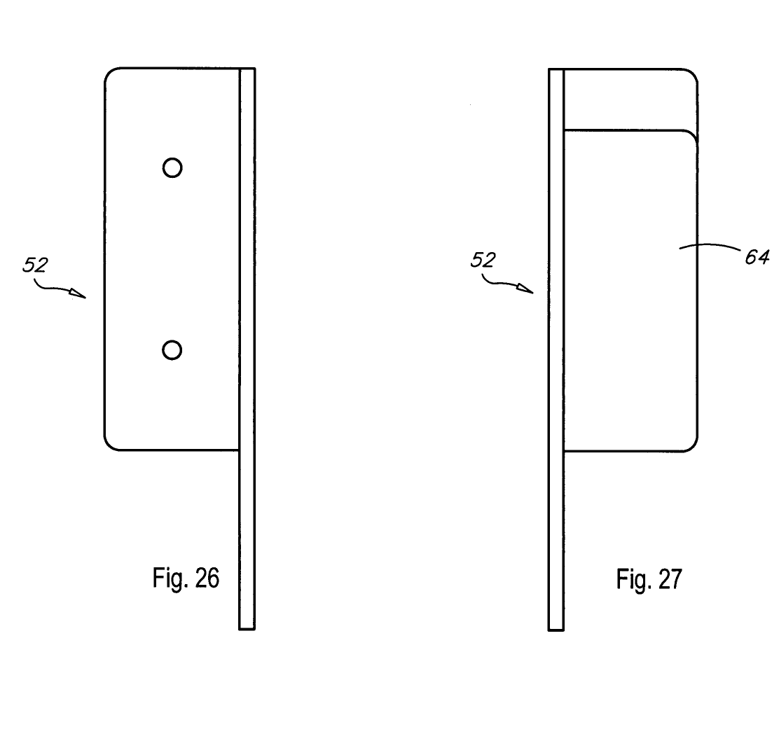

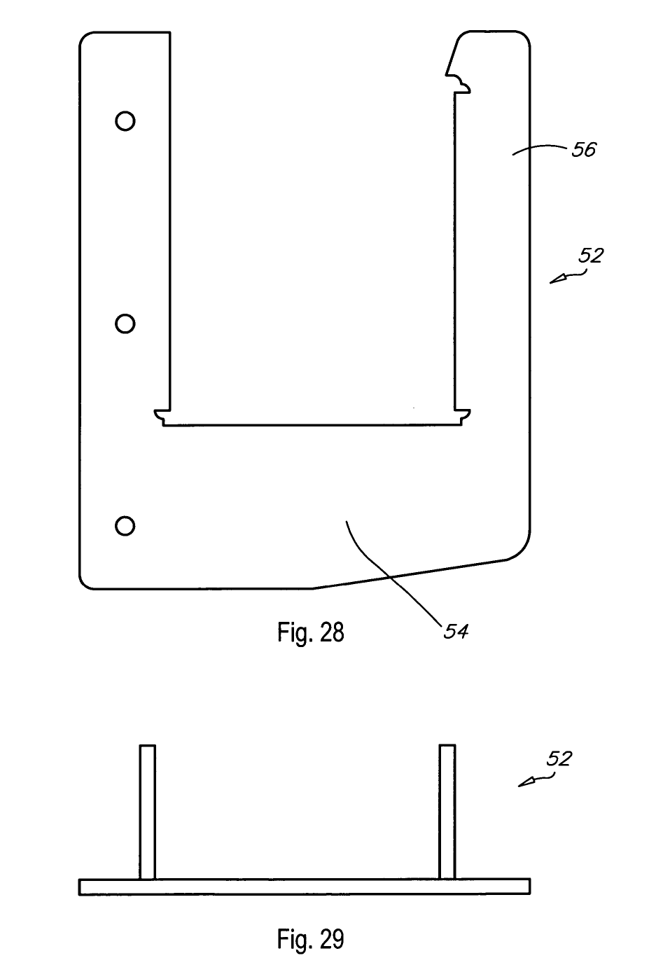

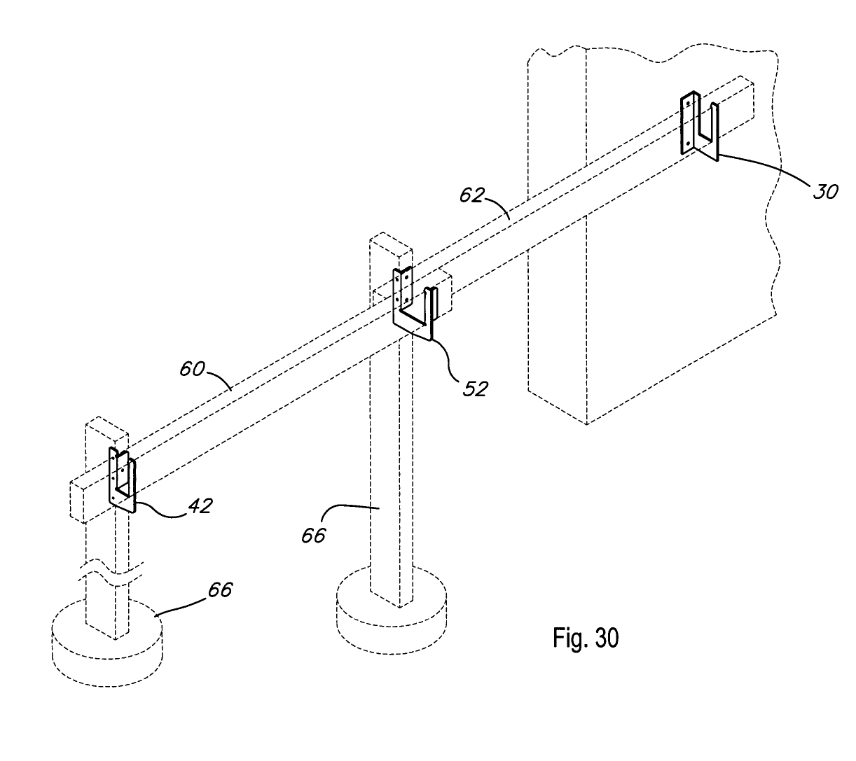

FIG. 23 is a perspective view of yet another bracket 52 in accordance with the invention. This bracket 52 is substantially identical to bracket 42, except that the support portion 54 extends further from the mounting portion so that together with the retaining portion 56 an opening 58 is defined that is wider than that defined by the brackets 2, 30 or 42. For example, in exemplary embodiments, brackets 2, 30 and 42 define openings about 2 inches wide, whereas the opening 58 defined by bracket 52 is about 4 inches wide. Thus, as shown in FIG. 30, two rails 60 and 62 can be supported and retained by the bracket 52. An additional feature of the bracket 52 is a supplemental retaining element 64 that helps to stabilize rails supported by the bracket 52. FIGS. 24-29, although not described separately below, illustrate the various features of the bracket 52 from differing perspectives.

FIG. 30 illustrates how a combination of brackets can be used to provide a modular fall protection system. For example, a first bracket 30 could be secured to an immovable wall, a second bracket 52 to a readily-portable stanchion 66 such as a 2″ by 4″ piece of wood held upright by a base, and a third bracket 42 to another stanchion. Similarly, the third bracket 42 could be wall mounted. Thus, the system allows fall protection to be provide for expansive openings using standard dimensioned materials (e.g., 8-foot long 2″ by 4″ timbers). Also, additional vertically-aligned brackets can be mounted to stanchions and walls to support a second rail.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A bracket for a wall opening fall protection support system for use with a rail, the bracket comprising:
a substantially planar mounting portion;
a substantially planar support portion extending orthogonally from the mounting portion; and
a substantially planar retaining portion extending from the mounting portion, the retaining portion being substantially coplanar with the support portion.

2. The system of claim 1, wherein the mounting portion of the bracket lies on only one side of the plane defined by the support portion.

3. The system of claim 2, wherein the support portion, the retaining portion, and the mounting portion define an opening for receiving the rail.

4. The system of claim 3, wherein the support portion, the retaining portion, and the mounting portion define an opening that is 2 inches by 4 inches.

5. The system of claim 3, wherein the support portion, the retaining portion, and the mounting portion define an opening that is 4 inches by 4 inches.

6. The system of claim 1, further comprising a second mounting portion that is disposed at 90 degrees with respect to the mounting portion.

7. The system of claim 6, wherein the second mounting portion is coplanar with the support portion.

8. The system of claim 1, wherein the bracket further includes engagement means for inhibiting motion of the rail with respect to the bracket.

9. A wall opening fall protection support system comprising:
a first substantially planar mounting portion;
a substantially planar support portion extending orthogonally from the mounting portion;
a second substantially planar mounting portion disposed at 90 degrees with respect to the first substantially planar mounting portion and coplanar with the substantially planar support portion;
a substantially planar retaining portion extending from the mounting portion, the retaining portion being substantially coplanar with the support portion; and
a rail,
wherein the support portion, the retaining portion, and the mounting portion define an opening for receiving the rail.

10. A fall protection system for use with walls and movable stanchions comprising:
a plurality of brackets securable to the walls and stanchions; and
a plurality of 2″ by 4″ by 8′ rails,
wherein the brackets are adapted to engage the rails.
